(19) United States
(12) Patent Application Publication
(10) Pub. No.: US 2018/0319116 A1
(43) Pub. Date: Nov. 8, 2018

(54) METHOD FOR THREE-DIMENSIONAL SHAPING OF FLAT MATERIAL

(71) Applicant: Pester Pac Automation GmbH, Wolfertschwenden (DE)

(72) Inventor: Hans HAUG, Bad Groenenbach (DE)

(73) Assignee: Pester Pac Automation GmbH, Wolfertschwenden (DE)

(21) Appl. No.: 15/971,507

(22) Filed: May 4, 2018

(30) Foreign Application Priority Data
May 8, 2017 (DE) 10 2017 109 879.8

(51) Int. Cl. B31F 1/00; B31D 5/02

(52) U.S. Cl. CPC B31F 1/0077; B31D 5/02; B65D 2543/00444; B65D 2543/00268; B31F 2201/0794

(57) ABSTRACT

A method for three-dimensional shaping of flat material, in particular material composed of natural fibers, such as paper or cardboard, for example, uses a deep-drawing piston and a die, through which or into which the material is drawn. The diameter of the deep-drawing piston plus the material thickness of the material to be deep-drawn corresponds at least approximately to the diameter of the die.

### CROSS REFERENCE TO RELATED APPLICATIONS

Applicant claims priority under 35 U.S.C. § 119 of German Application No. 10 2017 109 879.8 filed on May 8, 2017, the disclosure of which is incorporated by reference.

### BACKGROUND OF THE INVENTION

### 1. Field of the Invention

The invention relates to a method for three-dimensional shaping of flat material, in particular material composed of natural fibers, such as paper or cardboard, for example, using a deep-drawing piston and a die, through which or into which the material is drawn.

### 2. Description of the Related Art

Various methods are known for shaping of flat material, in particular deep-drawing methods.

It is problematical in the case of these methods that only thermoformable material, in other words mainly plastic films, can be shaped.

Papers and cardboards are generally deep-pressed, with significant wrinkle formation occurring.

Such shaped papers and cardboards must then first be smoothed at their edges, in complicated manner, for example so that a lid can be sealed on. Plastics are also often applied for smoothing.

### SUMMARY OF THE INVENTION

It is therefore an object of the invention to provide a method that avoids the aforementioned disadvantages when shaping paper and cardboard and provides a deep-drawing method for these materials.

This task is accomplished, according to the invention, in that the diameter of the deep-drawing piston plus the material thickness of the material to be deep-drawn corresponds at least approximately to the diameter of the die.

In this way, wrinkles that occur are immediately smoothed again, so that they are distributed in an extremely fine manner and no longer have a disruptive effect.

In this regard, it has proven to be very advantageous if the material is clamped in between the die and what is called a wrinkle holder, thereby allowing the material to slide along in targeted manner.

In this way, wrinkle formation is prevented to a great extent.

It is furthermore very advantageous, according to the invention, if the material is partially or completely pressed through the die during shaping.

In the case of partial pressing through, the deformations that are produced must be ejected upward, whereas they can fall downward when pressed through.

A further very advantageous embodiment of the invention is present if the die is configured as a plate, wherein it can have a thickness less than or equal to the shaping depth. In this way, a very good shaping result is ensured.

Furthermore, it is very advantageous, according to the invention, if the die-formed part, which is at first pot-shaped and provided with a cylindrical, oval or angular wall, is shaped using a mold. In this way, the desired shape can be produced very easily, and different wall inclinations or conicities can also be produced. Other shapes are conceivable.

In this regard, it has proven to be every advantageous if the shaping demonstrates different angles over its horizontal expanse. In this way, even further improved adaptation to the desired shape can take place. Die-formed parts are conceivable, which have different angles of the side walls over their horizontal expanse. As a result, any desired shapes are conceivable.

Furthermore, it has proven to be advantageous, in this regard, if shaping takes place in such a manner that one, preferably two conical sections are produced. In this way, a cone that is flattened toward the edge, for example, can be created.

It is also very advantageous, according to the invention, if the die-formed part is provided with a lid after having been filled, and sealed. In this way, the die-formed part can be closed off very well and reliably, and the content can be protected.

In this regard, it is extremely advantageous if the lid is sealed on using a punch. In this way, a simple and efficient possibility of connecting the lid with the die-formed part is created.

Furthermore, it has proven to be very advantageous if the die-formed part is held in a mold during sealing. In this way, undesirable deformations are prevented.

It is also very advantageous, according to the invention, if the die-formed part is trimmed during sealing. In this way, not only is the die-formed part sealed in one work step, but also an undesirable excess length is removed.

In this regard, it has proven to be extremely advantageous, according to the invention, if the mold in which the die-formed part is held is mounted in movable manner and can be pressed down against a spring. In this way, a possibility for trimming is created in simple manner. In place of a spring, mechanical control or forced control, for example, can also be provided.

Furthermore, it has proven to be very advantageous, according to a further embodiment of the invention, if the edge of the die-formed part is shaped and/or bent during sealing. In this way, the edge can be brought into a desired contour once again. During bending, it is also possible to compensate tensions that occur in the lid and to thereby prevent an undesirable drum effect.

A very advantageous apparatus, according to the invention, for carrying out the method described above is present if a die and a deep-drawing piston are provided, wherein the die can have a thickness that is less than or equal to the deep-drawing height.

In this way, a very good possibility is created for deep-drawing material that lies flat, in particular paper material, in other words to shape it into a three-dimensional die-formed part.

In this regard, it is very advantageous if a counter-punch is provided. In this way, the deep-drawing process is improved and can be controlled more precisely.

Furthermore, according to a further embodiment of the invention, it is particularly advantageous if a mold for holding the die-formed part and a shaping punch are provided, which punch has a conical shape having at least one slant. In this way, the vertically oriented walls of the die-formed part can be widened in targeted manner.

In this regard, it is extremely advantageous, according to the invention, if the shaping punch has a slant such that the edge of the die-shaped part can slide along it, wherein the slant can assume an angle relative to the horizontal of about 20°.

As a result, the free end of the pre-die-formed part does not have to be treated in targeted manner once again. Instead, it is sufficient, in order to achieve widening, to work with this shaping punch. Equalization of length and circumference takes place by means of the sliding.

Furthermore, it has proven to be very advantageous, according to the invention, if a sealing mold and a sealing punch are provided, wherein the size of the sealing mold and of the sealing punch can be coordinated with one another. In this way, perfect sealing of a lid onto the die-formed part can be produced.

It is also extremely advantageous, according to a further development of the invention, if a cutting device is provided. Using a cutting device, it is possible to trim the die-formed part, for example, and also the lid, if necessary, in each instance.

It has also proven to be very advantageous if the sealing mold is mounted in movable manner, wherein this mold can be configured so that it can be pressed down against a spring. In this way, the sealing process can be controlled very well. It is conceivable that in this regard, an edge that surrounds the sealing mold acts as a cutting device for trimming the die-formed part and the lid, and thereby sealing and trimming can take place in one work step. An additional cutting device is conceivable. In place of a spring, mechanical control or forced control can also be provided.

Furthermore, it is very advantageous if the sealing mold and the sealing punch have a contour that is able to further shape, press and/or bend at least one edge of the die-formed part. In this way, as well, multiple work steps can be combined into one process step.

It is also very advantageous, according to a further development of the invention, if the press-down force or sealing force during sealing of the die-formed part with a lid is limited by means of corresponding spring arrangements, controllers or the like. In this way, it is prevented, for example, that the material of the lid and/or the die-formed part is actually squashed. Furthermore, an overly great sealing force can also have a negative effect with regard to the durability of the seam. In total, the process becomes thereby very easy to control and monitor.

Another very advantageous further development of the invention is also present if a moistening device and/or a heating device for the material is/are provided. In this way, the results of the shaping steps can be clearly improved once again, since above all, paper, paperboard, and cardboard that are used can be better deformed and shaped.

### BRIEF DESCRIPTION OF THE DRAWINGS

In the following, the invention will be illustrated using an exemplary embodiment.

The figures show:

FIG. 1 a flat cardboard cutout for a die-formed part,

FIG. 2 an apparatus for shaping or deep-drawing a pre-die-formed part, equipped with perpendicular walls,

FIG. 3 a representation of the die-formed part,

FIG. 4 an apparatus for shaping the pre-die-formed part, having a mold and a shaping punch,

FIG. 5 a representation of the die-formed part,

FIG. 6 a representation of a shaping arrangement when widening the die-formed part,

FIG. 7 a detail representation of the shaping punch,

FIG. 8 an apparatus for sealing, bending and trimming a finished packaging unit.

### DETAILED DESCRIPTION OF PREFERRED EMBODIMENTS

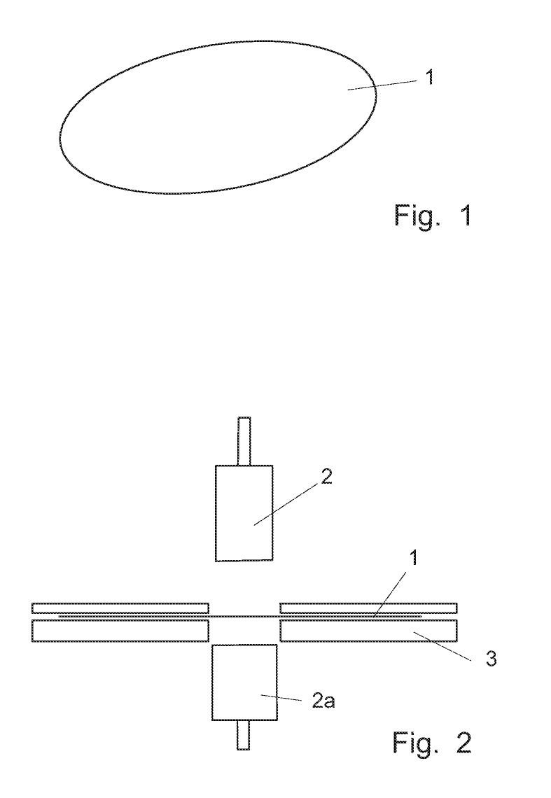

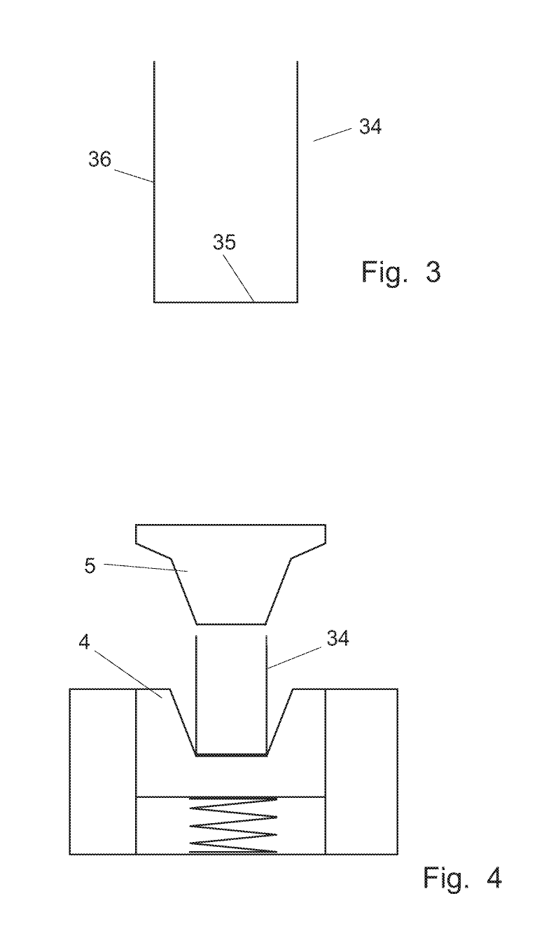

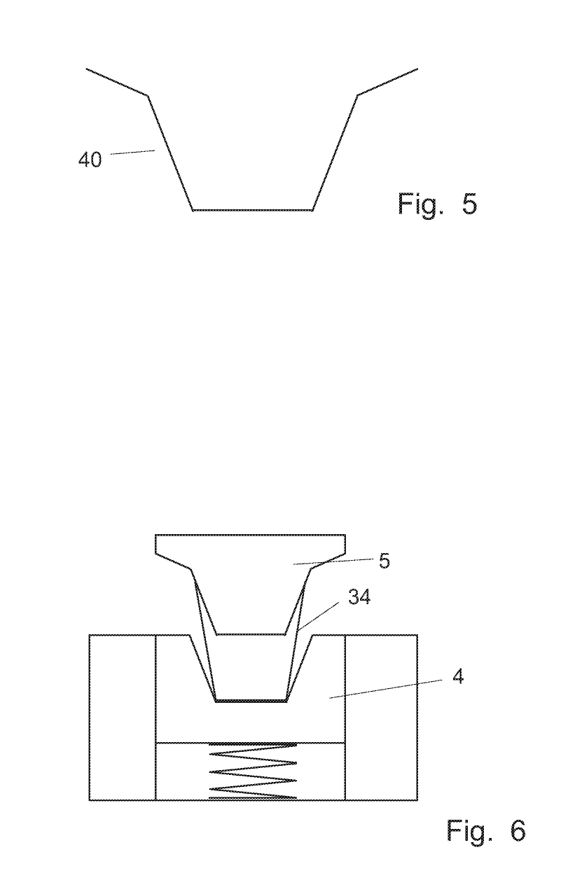

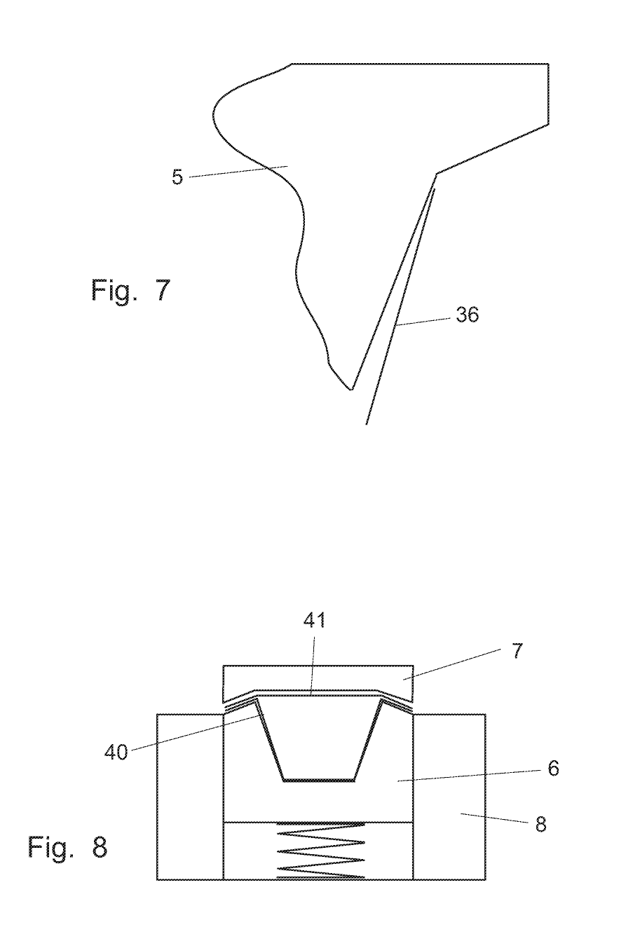

In FIG. 1, a paper material cutout, which is shaped in three dimensions by means of a shaping punch 2 and a die 3, is indicated as 1. The diameter of the shaping punch 2 plus twice the material thickness corresponds at least approximately to the diameter of the die 3.

The die 3 is configured as a recess in a material plate, preferably a steel plate. The paper material cutout 1 is pressed through the die using the shaping punch 2. As a result, a pot-shaped die-forming part 34 having a bottom 35 and cylindrical walls 36 is formed.

Any wrinkles that form in the paper or cardboard material 1 are not only finely distributed by the narrow gap between shaping punch 2 and die 3, but they are also immediately smoothed, so that they do not become noticeable or act disruptively.

In this regard, the shaping punch 2 can either be pressed so deeply into the die 3 that an edge still remains, in other words the die-forming part 34 is not pressed completely through the die 3, or, alternatively, the shaping punch 2 is pressed so deeply into the die 3 that no edge remains, and the die-forming part 34 is pressed at least so far into the die 3 or through it such that the part just ends in the die 3 or falls through it.

In this regard, the die 3 can be configured to be relatively thin, in other words the thickness of the die 3 can be clearly thinner than the height of the die-forming part 34. During the shaping process, deflection of the horizontal, flat paper cutout into the three-dimensional, pot-shaped mold is important.

During the shaping process, an additional counter-punch 2a can also be provided, which clamps the paper material between the deep-drawing punch and itself. A hold-down device, which holds the flat material against the die 3 and allows targeted, defined and controlled sliding along of the flat material can be provided.

However, since cylindrical die-forming parts are frequently not desired, but rather conical parts are desired, a possibility is presented below for converting these cylindrical die-forming parts 34 into conical containers.

For this purpose, the die-forming part 34 is placed into a conical mold 4. A correspondingly shaped punch 5 moves into the die-forming art from above and widens it. In this regard, the die-forming part is brought into a conical mold and pressed between the mold 4 and the punch 5.

A conical die-forming part 40 is formed. In this regard, both punch 5 and mold 4 can have two or even more conical sections—as shown in the exemplary embodiment. A combination of conical and cylindrical sections is also conceivable.

In this regard, it is important that the base area of the die-forming part is in fact circular. Oval, angular or irregular outlines are also conceivable.

In order to guarantee good shaping ability, it is practical if the individual sections of the punch 5 and of the mold 4 are inclined at least 20° relative to the horizontal. By means of this inclination, the open edge of the die-forming part 34 can slide along the slant of the punch 5, thereby preventing compression of the cylindrical die-forming part 34.

In a next step, the die-forming part 40 formed in this way is filled and subsequently sealed with a lid 41. In this exemplary embodiment, the lid 41 is level and is sealed onto the pre-forming part. Other lids and other connection methods are conceivable.

When the lid 41 is being sealed on, the edge of the die-forming part 40 is bent, in other words deformed further downward. In this manner, the lid 41 is prevented from stretching and an undesirable drum effect is prevented from occurring. For this purpose, the die-forming part 40 is placed into a corresponding mold 6 and bent from above with a punch 7. At the same time, the lid 41 that has already been put into place is connected with the die-forming part 40.

However, it is also conceivable that no bending takes place and that the mold 6 only has a horizontal outlet.

In the exemplary embodiment shown, the mold 6 is mounted in a holder 8 in movable manner, so that when the edge is pressed down, i.e. bent, the edge and the lid 41 can also be simultaneously trimmed. The edge between mold 6 and holder 8 can be used for this purpose. A separate severing device is conceivable. In this regard, the mold 6 can be held under stress by a spring in the holder 8. Likewise, mechanical or hydraulic control is conceivable.

In total, a three-dimensional cup or a three-dimensional cartridge is thereby formed from a flat paper or cardboard material, in simple manner. Such cartridges can be used, for example, for preparation of hot or cold beverages, like known coffee cartridges composed of plastic.

Depending on the desired period of storage, these cartridges can be equipped with a barrier layer or can also be packaged in individual packs or multi-packs.

What is claimed is:

1. A method for three-dimensional shaping of flat material, in particular material composed of natural fibers, such as paper or cardboard, the shaping comprising drawing the flat material using a deep-drawing piston and a die, wherein a diameter of the deep-drawing piston plus a material thickness of the material to be deep-drawn corresponds at least approximately to the diameter of the die.

2. The method according to claim 1, wherein during shaping, the material is clamped between the die and a wrinkle holder, such that the material slides along in a targeted manner.

3. The method according to claim 1, wherein the material is pressed through the die, partially or completely, during shaping.

4. The method according to claim 1, wherein the die is configured as a plate, and wherein the plate has a thickness less than or equal to a shaping depth.

5. The method according to claim 1, wherein the method forms a pot-shaped die-formed part that is with a cylindrical, oval or angular side wall, and further comprising shaping the die-formed part by means of a mold.

6. The method according to claim 5, wherein the step of shaping by means of the mold causes the die-formed part to have different angles over horizontal expanse.

7. The method according to claim 5, wherein at least one conical section is produced.

8. The method according to claim 5, further comprising filling the die-formed part, providing a lid for the die-formed part and sealing the die-formed part with a lid.

9. The method according to claim 8, wherein the lid is sealed on by means of a punch.

10. The method according to claim 8, wherein the die-formed part is held in the mold during the step of sealing.

11. The method according to claim 8, wherein the die-formed part is trimmed during the step of sealing.

12. The method according to claim 11, wherein the mold is mounted in a movable manner and is configured to be pressed down against a spring.

13. The method according to claim 8, wherein an edge of the die-formed part is shaped and/or bent during sealing.

14. An apparatus for three-dimensional shaping of flat material composed of natural fibers such as paper or cardboard, comprising a die and a deep-drawing piston, wherein the die has a thickness that is less than or equal to a deep-drawing height.

15. The apparatus according to claim 14, further comprising a counter-punch.

16. The apparatus according to claim 14, further comprising a mold for accommodating the die-formed part, and a shaping punch having a conical shape having at least one slant.

17. The apparatus according to claim 16, wherein the shaping punch has a slant such that an edge of the die-formed part slides along the edge during shaping, wherein the slant has an angle relative to horizontal of about 20°.

18. The apparatus according to claim 14, further comprising a sealing mold and a sealing punch, wherein a size of the sealing mold and of the sealing punch are coordinated with one another.

19. The apparatus according to claim 14, further comprising a cutting device.

20. The apparatus according to claim 18, wherein the sealing mold is mounted in movable manner, and is configured to be pressed down against a spring.

21. The apparatus according to claim 18, wherein the sealing mold and the sealing punch have a contour that is configured to further shape, press and/or bend at least one edge of the die-formed part.

22. The apparatus according to claim 18, further comprising spring arrangements or controllers that are configured for limiting a press-down force during closing of the die-formed part with a lid.

23. The apparatus according to claim 14, further comprising a moistening device and/or a heating device for the material being shaped.
